(19) United States
(12) Patent Application Publication
(10) Pub. No.: US 2007/0200391 A1
(43) Pub. Date: Aug. 30, 2007

(54) Method for the Production of a Vehicle Component, Particularly a Chassis Frame

(75) Inventor: Volker Thoms, Rabenau-Oelsa (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/577,934

(22) PCT Filed: Oct. 14, 2004
(86) PCT No.: PCT/EP04/11519

§ 371 Date: Feb. 21, 2007

(30) Foreign Application Priority Data
Nov. 3, 2003 (DE) 103 51 137.7

(51) Int. Cl. B60R 27/00

(52) U.S. Cl. 296/187.08

(57) ABSTRACT

In a method for producing a vehicle component, such as a chassis frame, which is equipped with spring strut mountings, elongate, tubular longitudinal member hollow profiles, which run parallel and are spaced apart from one another in the horizontal plane, are connected at the respective longitudinal member ends nonreleasably to one another by tubular cross member hollow profiles, to secure a crossbar for receiving a rear axle, a differential and a transverse link, and a crossbar, which is spaced apart in the longitudinal direction and is intended for the securing of a transmission between the two end-side cross member hollow profiles, on the longitudinal member hollow profiles, to form the size and shape of the cross section of the longitudinal member hollow profiles in an expanding manner by means of internal high pressure forming, to form body mountings of the frame by forming secondary shaped elements laterally from the longitudinal member hollow profile by means of exertion of a fluidic internal high pressure and subsequent vertical perforation of the secondary shaped elements, and to likewise form bearing mountings of longitudinal links, as secondary shaped elements, laterally outward from the longitudinal member hollow profile by means of fluidic internal high pressure and subsequently to perforate them.

### BACKGROUND AND SUMMARY OF THE INVENTION

This application is a National Phase of PCT/EP2004/011519, filed Oct. 14, 2004, and claims the priority of German patent document DE 103 51 137.7, filed Nov. 3, 2003, the disclosure of which is expressly incorporated by reference herein.

The invention relates to a method for the production of a vehicle component, particularly a chassis frame.

Chassis frames of motor vehicles are usually made up of profiled longitudinal member plates, transverse member plates as transverse end connections of the longitudinal members, crossbar plates for securing the transmission and the axle mountings. Longitudinal and transverse link bearings, body mountings and the spring strut mountings are also connected to the longitudinal members as console plates belonging to the frame. The numerous individual parts are generally connected to form a high-value frame either by conventional welding methods, or mechanically (for example, by means of bolts). The magnetic pulsed-current welding method described in International patent document WO 97/00151 is an example of a particular joining technique.

The number of different parts used in these known frame constructions is very high due to the accumulation of functions; thus complicated production of individual parts, and varied joining operations are required, which are frequently difficult to carry out (also because of meager construction spaces). As a result, in addition to high storage costs for the individual parts, the production of the entire frame is relatively expensive. Furthermore, extremely high demands are imposed on the joining connections in terms of mechanical load-bearing capacity which they do not meet, at least with the service life over the medium to long term. As a result, cracks or even breaks at the joining points inevitably cause damage which impairs driving safety

Furthermore, the public has ever greater expectations in terms of safety and comfort with regard to roadholding. As a result, a main feature in the production of a frame is the greatest possible flexural and torsional rigidity. The known sheet-metal construction cannot adequately meet this expectation.

One object of the invention, therefore, is to provide a simple method for the production of a vehicle component which permits a very complex design form with substantially improved stability of the component. Another object of the invention is to provide such a method which minimizes the need for diversity of the components.

These and other objects and advantages are achieved by the method according to the invention. In particular, by designing the cross members as tubular hollow profiles, and the crossbars and longitudinal members as hollow profiles, the torsional and flexural rigidity, and therefore the stability of the entire frame, are improved quite considerably. The special “construction-space-matched” and precise design of the cross-sectional shape and surface profile of the longitudinal member by internal high pressure forming provide a relatively simple and economical technique which accommodates a complex design of components (in particular of the chassis frame) during the expansion of the longitudinal member hollow profiles. In this manner, the body mountings and the bearing mountings for the longitudinal links are likewise formed in a single working step laterally from the longitudinal member hollow profile as secondary shaped elements. These are subsequently, of course, to be perforated, for example by drilling or punching.

This possibility of forming said mountings or other consoles of complex configuration (which are otherwise used as separate add-on parts, to be joined onto the longitudinal members) from the longitudinal member hollow profile material with little outlay (and therefore the ability to achieve unity of various functional components of the component) permits an extremely high degree of integration and substantially reduces the necessary diversity of components. In this connection, the component does not suffer from any losses of rigidity whatsoever, and at the same time no weak points are produced in the mechanical load-bearing capacity due to consoles being joined to the longitudinal member, so that the stability is ensured.

Furthermore, the improved torsional and flexural rigidity of the component achieved by designing its members in the form of hollow profiles configured by internal high pressure, permits the wall thickness of the component to be reduced, so that weight in the component or frame construction is saved. This saving is highly beneficial to the lightweight construction of motor vehicles that is generally required for lowering emissions and saving fuel. From the great variety of vehicle frames, in addition to the chassis frame and the frame structure of the body, use of the method according to the invention is also conceivable, for example, in the case of a seat frame.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of the rear portion of a chassis frame according to the invention;

FIG. 2 is a perspective view of the front part of a chassis frame according to the invention, directly adjoining the rear part from FIG. 1;

FIG. 3 is a perspective view of the spring strut mounting of the front part of the chassis frame from FIG. 2;

FIG. 4 is a perspective view of the crossbars of the chassis frame according to the invention, from FIGS. 1 and 2, in a joining position;

FIG. 5 is a perspective view of a body mounting of the rear part of the chassis frame from FIG. 1;

FIG. 6 is a perspective view of a bearing mounting of a longitudinal link in the rear part of the chassis frame from FIG. 1;

FIG. 7 is a perspective view of a body mounting of the rear part of the chassis frame from FIG. 1, which body mounting has been produced by pinching the longitudinal member hollow profile;

FIG. 8 shows a cross section of the body mounting from FIG. 7;

FIG. 9 is a cross sectional perspective view of a longitudinal member hollow profile of the chassis frame according to the invention with form-fitting elements;

FIG. 10 shows the production of a spring strut mounting of the chassis frame according to the invention in a perspective view of the bent shape of the section of the longitudinal member hollow profile after a first bending step;

FIG. 11 shows the bent shape of the spring strut mounting from FIG. 10 after a second bending step;

FIG. 12 shows the bent shape of the spring strut mounting from FIG. 11 after a third bending step;

FIG. 13 shows the fully bent spring strut mounting from FIG. 10 after the fourth bending step; and

FIG. 14 shows the spring strut mounting from FIG. 13 after flattening and perforating.

### DETAILED DESCRIPTION OF THE DRAWINGS

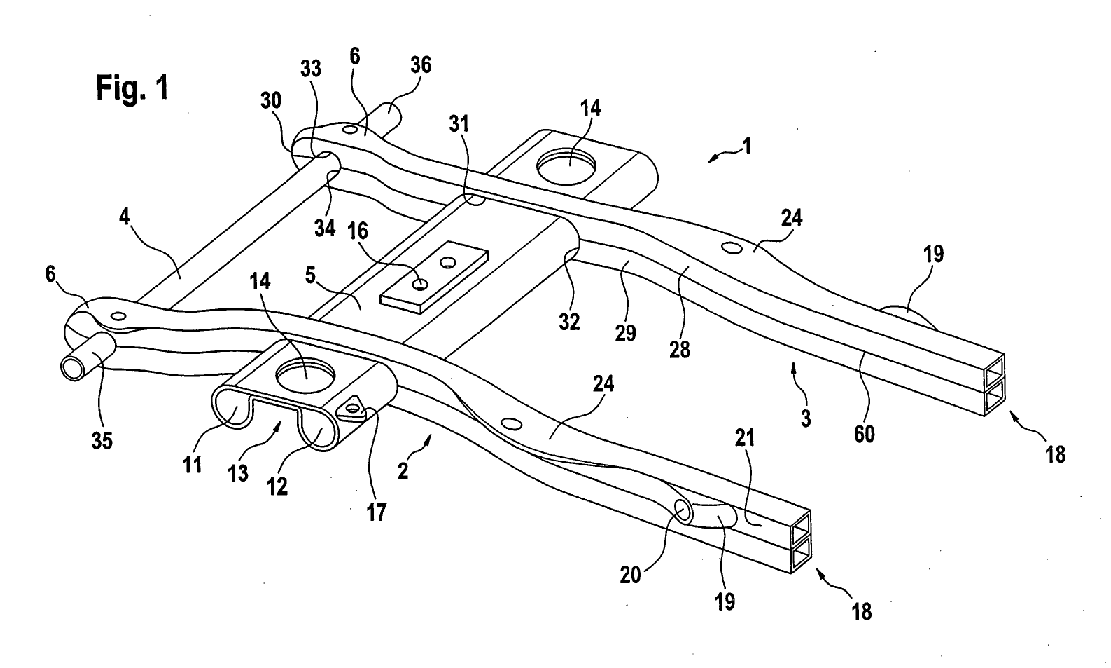

FIG. 1 illustrates a rear part of a chassis frame 1 of a motor vehicle (in particular, an off-road vehicle), which includes two longitudinal member hollow profiles 2, 3 that are parallel to each other and spaced apart in the horizontal plane, a tubular cross member hollow profile 4, a hollow-profile-like crossbar 5 for receiving a rear axle, a differential and a transverse link, and also body mountings 6, 24 of the frame 1 and bearing mountings 19 of longitudinal links.

The hollow profile 4 for the rear cross member is designed in blank form as a tube, and can be expanded into its final form by internal high pressure forming in a manner matched to construction space conditions or functional requirements. It is also possible to leave the hollow profile 4 in the blank form, which is simple and cost effective in terms of method for producing the entire frame 1.

The wide-surfaced hollow crossbar 5 is formed from an oval tube. The oval tube is placed into a divided internal high pressure forming die and, after the forming die is closed, one longitudinal side 9 of the oval tube is pressed in in the central region 67 over the entire longitudinal extent of the tube by means of a punch, which is integrated in the forming die, until the two longitudinal sides 9 and 10 of the undeformed oval tube, which sides run parallel and rectilinearly, come to bear against each other. This results in the formation of two cavities 11 and 12 which contain—as seen in the width direction—the curvatures of the oval tube and are spaced apart by a channel 13 which has a pressed-in longitudinal side 9 as base. The cavities 11 and 12 are then closed by axial punches so that high-pressure liquid can be introduced into the interior of the cavities 11, 12. While the press-in punch remains in its pressed-in position, the cavities 11, 12 are placed under internal high pressure with the longitudinal sides 9, 10 therefore remaining permanently against each other (FIG. 1). Next, they are deformed in an expanding manner to form tubes 68 running parallel and having a virtually circular cross section in accordance with the impression of the internal high pressure forming die and the contour of the punch. After the tension of the hydraulic liquid is released, the punch is pulled back, and after subsequent opening of the internal high pressure forming die, a crossbar 5 can be removed from the latter. Such a crossbar has high flexural rigidity because it is designed at the two width ends 69 (FIG. 4) in a manner similar to a cylindrical tube, and very great torsional rigidity because of the single-piece connection of the ends 69 by means of a web. The latter is in the form of a sheet-metal double layer formed by the longitudinal sides 9, 10 of the oval tube.

It is similarly possible to replace the punch by an appropriate design of the impression of the forming die, so that the oval tube is pressed in at its longitudinal side 9 by the closing operation of the internal high pressure forming die, which simplifies the entire die and the process control. Furthermore, it is also possible to perform the pressing-in under internal high pressure. Under some circumstances, this may improve the process reliability, since the tube material is already fluid during the pressing-in operation and can therefore be more easily formed. Since, however, the longitudinal ends of the oval tube cannot be pressed in on account of the sealing punch which is required, the oval tube has to be shortened on both sides in a subsequent cutting operation, which undesirably increases outlay and costs for producing the crossbar 5.

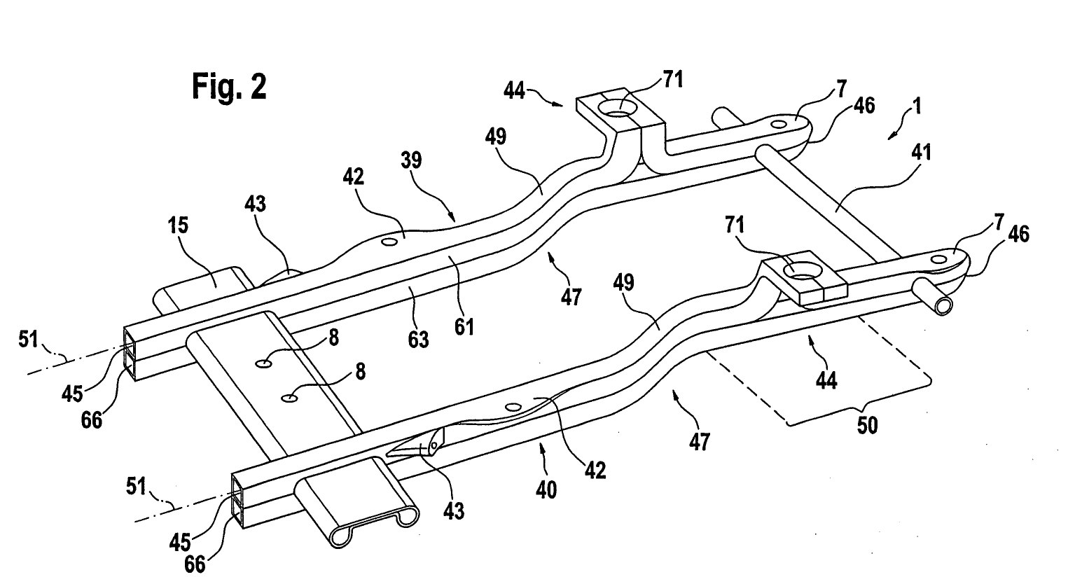

Furthermore, the oval tube does not necessarily have to be pressed in only on one longitudinal side 9; rather this can also take place at its longitudinal side 10 by a second punch at the same time as or offset in time to the pressing-in of the longitudinal side 9. The web formed by the double sheet-metal layer then lies at least approximately in the axial plane of the longitudinal axes 70 of the two cavities 11 and 12. Finally, in the pressed-together central region 67 of the longitudinal sides 9, 10, the rear axle mountings 14, the securing mountings 16 for the differential (not shown here) and, in the case of the crossbar 15 (which is shown in FIG. 2 and is designed identically to the shape of the crossbar 5), the securing holes 8 for securing the transmission (FIG. 4) are punched out or produced by metal-cutting in a simple manner. It is also possible to perform the punching operation within the internal high pressure forming die, with or without internal high pressure, which saves further clamping and facilitates exact reproducibility of the location of the mountings.

Furthermore, it is also possible to achieve a further increase in stiffening by introducing beads running diagonally, preferably crosswise, over the double sheet-metal layer, by means of an impressing punch integrated in the internal high pressure forming die. Finally, a further securing means 17 can be fitted on the crossbar 5 for the transverse link.

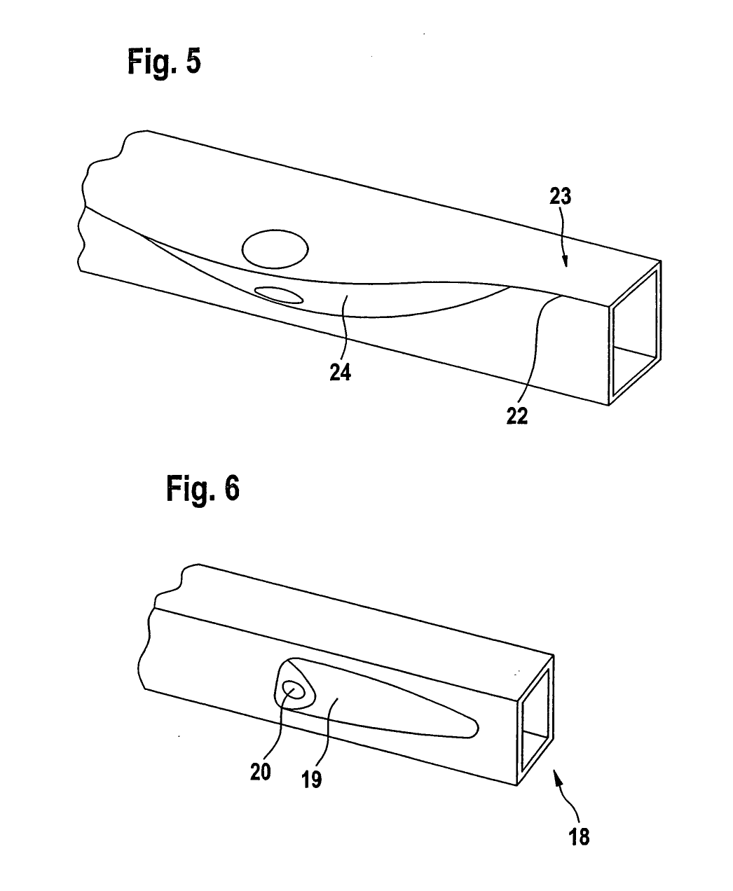

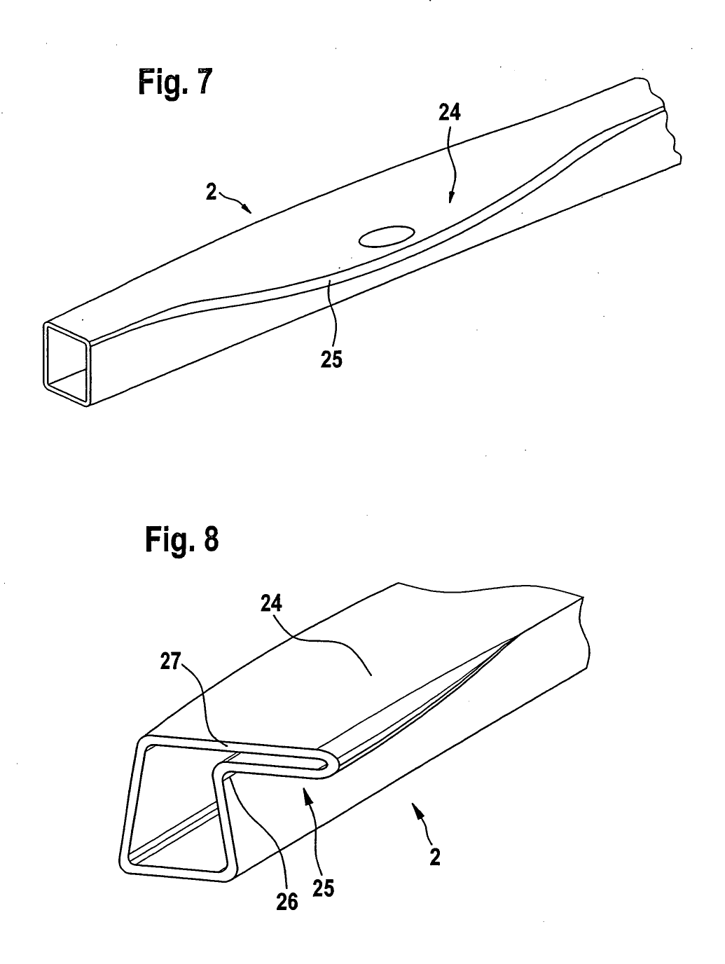

The size and shape of the cross section of the longitudinal member hollow profiles 2, 3 are expanded by internal high pressure forming—for example, as here, from a tubular blank with a circular cross section into a final form with a rectangular cross section—and, as a result, are matched to the construction space conditions. In order, to avoid the degrees of forming becoming too large, the internal high pressure forming process can be preceded by mechanical forming processes, for example bendings and/or pinchings of the hollow profile 2, 3. At the same time as the creation of the cross-sectional shape and size assisted by internal high pressure, bead-like secondary shaped elements are formed laterally outward from the longitudinal member hollow profile 2, 3 (i.e., on the side which faces away from the respectively other longitudinal member hollow profile 2, 3) by the application of fluidic internal high pressure (in particular FIGS. 5 and 6).

These secondary shaped elements, which are formed in both the rear and front parts of the chassis frame 1, are situated, on the one hand, in the rear part upward directly adjacent to the cross member 4 and, on the other hand, on that side of the crossbar 5 which faces away from the cross member and in the vicinity of that end 18 of the longitudinal member hollow profile 2, 3 which points toward the front part of the chassis frame 1. The secondary shaped elements formed at this end 18 provide bearing mountings 19 with longitudinal links. The receiving holes 20 subsequently are produced in the normal direction or horizontally at an oblique angle with respect to the outside 21 of the longitudinal member hollow profile 2, 3. The other secondary shaped elements mentioned, which contain the lateral edge 22 of the upper side 23 of the respective hollow profile 2, 3 and constitute there, as it were, an extensive expansion of the upper side 23, are perforated vertically and form body mountings 24 of the frame 1.

FIGS. 7 and 8 show a variant to the design of the secondary shaped element of FIG. 5 (i.e., the body mountings 24). There are a number of possibilities for their production: First, as previously known, the secondary shaped element can be formed in a first internal high pressure forming die, and then, by closing a second internal high pressure forming die (different from the first one with regard to the impression at the location of the secondary shaped element), to pinch the secondary shaped element flat (with a radially protruding sheet-metal fold 25 being formed). Thereafter, radiating creases or indentations arising in the sheet metal of the hollow profile 2, 3 due to the pinching are equalized by application of an internal high pressure in the hollow profile 2, 3. Whereas FIG. 7 illustrates the final shape, FIG. 8 shows the state of the hollow profile 2, 3 after the pinching and before compensation of the indentations. Secondly, after the formation of the secondary shaped element by the punch integrated in the forming die, it is possible to act upon the secondary shaped element in the vertical direction in such a manner that the discussed sheet-metal fold 25 arises. In this manner, cost-intensive internal high pressure forming die which takes up construction space, can be avoided, and the pressure control simplified, since the internal high pressure applied for forming the secondary shaped elements can remain. However, additional control with regard to the movement of the punches is required.

It is also possible to pinch the sheet-metal fold 25 outside an internal high pressure forming die. Following the formation of the sheet-metal fold 25, the body mountings 24 are perforated vertically. This can take place (as also in the case of the bearing mountings 19 of the longitudinal links) by means of hole punches integrated in the internal high pressure forming die. The sheet-metal fold 25, at which the two fold walls 26 and 27 lie tightly against each other, makes it especially simple to punch through, and advantageously helps to ensure the dimensional accuracy of the body mounting 24.

Although the cross member 4 and the crossbar 5 corresponding to the front cross member 41 and the crossbar 15 of the front frame part can be fitted releasably or nonreleasably to the elongate tubular longitudinal member hollow profiles 2, 3 and 39 and 40 with known means (such as by welding, adhesive bonding, screwing or riveting), in this exemplary embodiment an entirely different, advantageous path is taken.

It is essential in this case that the longitudinal member hollow profiles 2, 3 are doubled into a lower and an upper hollow profile strand 28, 29, so that, with the two strands 28, 29 bearing tightly against each other, a respective double chamber hollow profile is formed, which considerably increases the flexural rigidity of the longitudinal members. The doubling comes about here as a result of the fact that the respective, originally single-stranded longitudinal member hollow profile 2, 3 is bent back through 180° on itself about a horizontal axis running transversely until the two resultant hollow profile strands 28, 29 come to lie on each other. The starting length of the longitudinal member hollow profile 2, 3 used has, of course, to be doubled for this for expedient use in vehicle construction. The bent edge 30 now forms the one end of the longitudinal member.

It is now possible, first, to place the cross member 4 and the crossbar 5 onto the one half of the longitudinal member hollow profile 2, 3 and, during the bending-back operation, to clamp them by the two strands 28 and 29 in the manner of a pair of tongs. This results in crushed deformations of the cross member 4, the crossbar 5 and the longitudinal member hollow profile 2, 3. However, undesired deformations can be equalized by applying an internal high pressure in the longitudinal member hollow profile 2, 3, so that the hollow profile 2, 3 are matched to the deformed contours of the cross member 4 and of the crossbar 5. The pressure to be applied for this matching is selected in such a manner that the cross member 4 and the crossbar 5 are firmly and nonreleasably enclosed in a press fit by the strands 28, 29 of the longitudinal member.

During internal high pressure forming of the longitudinal member hollow profile 2, 3, in which at the same time the secondary shaped elements for the body mountings 24 and the bearing mountings 19 for the longitudinal links can also be formed, a fluidic counterpressure is built up in the crossbar 5 and in the cross member 4. Such counterpressure prevents the pressure forming in the longitudinal member hollow profiles 2, 3 from reaching over to the crossbar 5 and the cross member 4, and undesirably deforming or even destroying them. In this variant, the crossbar 5 and the cross member 4 always remain deformed by crushing.

It is advantageous in the case of this technique for production of the connection between the longitudinal member hollow profiles 2, 3 and the cross member 4 and the crossbar 5, that in addition to the press fit obtained, these components are intimately connected by formation of a form-fitting connection, due to the crushed contours of the components caused by internal high pressure to engage in one another in a manner corresponding to the shape, which considerably increases the strength of the connection. However, during the crushing of the connecting parts (crossbar 5, cross member 4 and longitudinal member hollow profile 2, 3), damage to these parts, such as cracks, etc., may occur leading to reject parts because of the resultant lack of reliability during operation, and therefore the potential risk to the operating safety. The consequence of this would be an increased outlay on quality control.

Second, before bending those regions of the longitudinal member hollow profile 2, 3 which are indirectly adjacent on both sides to the bent edge 30, it is possible to introduce depressions 31, 32, 33 and 34 into the longitudinal member hollow profiles 2, 3 mechanically by means of a punch or by internal high pressure forming of the longitudinal member hollow profile 2, 3 in an internal high pressure forming die, after which the cross member 4 and the crossbar 5 are placed into the resulting depressions. After the bending operation, such components are likewise extensively enclosed, as in the preceding variant, but remain undeformed with regard to crushings, since the depressions 31-34 are matched in their depth and contour with play to the dimensions of the cross member 4 and of the crossbar 5.

After the cross member 4 and the crossbar 5 are enclosed between the hollow profile strands 28, 29, the longitudinal member hollow profiles 2, 3 are expanded by a fluidic internal high pressure, such that, on the one hand, the longitudinal member hollow profile 2, 3 is immovably press fitted on the cross member 4 and on the crossbar 5 and, on the other hand, the body mountings 24 and the longitudinal link bearing mountings 19 are formed. In this case, both the cross member 4 and the tubular cavities 11, 12 of the crossbar 5 are acted upon by a fluidic counterpressure which prevents the crossbar 5 and the cross member 4 from being compressed by the internal high pressure in the longitudinal member hollow profiles 2, 3.

As an alternative, it is also conceivable to achieve the press fit by internal high pressure in the cavities of the crossbar 5 or in the cross member 4, with the crossbar 5 or the cross member 4 being locally expanded at the location of the leadthroughs formed by the depressions 31-34 of the longitudinal member hollow profiles 2, 3. In this case, a deformation-preventing counterpressure has to prevail in both strands 28, 29 of the longitudinal member hollow profile 2, 3, which counterpressure is lower than the internal high pressure within the cavities 11, 12. The difference in pressure must be such that an expansion of the cavities 11, 12 so that, after the process is ended, material of the hollow profile strands 28, 29 springs back, producing the press fit. However, this press fit may be of sufficient size—given a simultaneously corresponding high internal pressure in the crossbar 5—such that the body mountings 24 and the bearing mountings 19 are formed in the upper hollow profile strand 28. It is likewise conceivable in this case already to form these mountings 24 and 19 by internal high pressure forming before the bending of the longitudinal member hollow profile 2, 3. In all cases, the perforations of the mountings 19 and 24 must not take place, for sealing reasons, until after the crossbar 5 and the cross member 4 are connected to the longitudinal member hollow profiles 2, 3. The end sections 35 and 36 of the cross member 4 and the rear axle mountings 14 of the crossbar 5 now protrude through the hollow profile strands 28, 29, which lie on each other, of the longitudinal member.

In every case, the achievement of a nonreleasable connection of the longitudinal member hollow profiles 2, 3 with the crossbar 5 is facilitated by the fact that, by means of the configuration of the crossbar (double tubular profile with spacing double sheet-metal layer), the crossbar 5 is grasped in a form-fitting manner in the course of the expansion of the longitudinal member hollow profiles 2, 3 by means of internal high pressure.

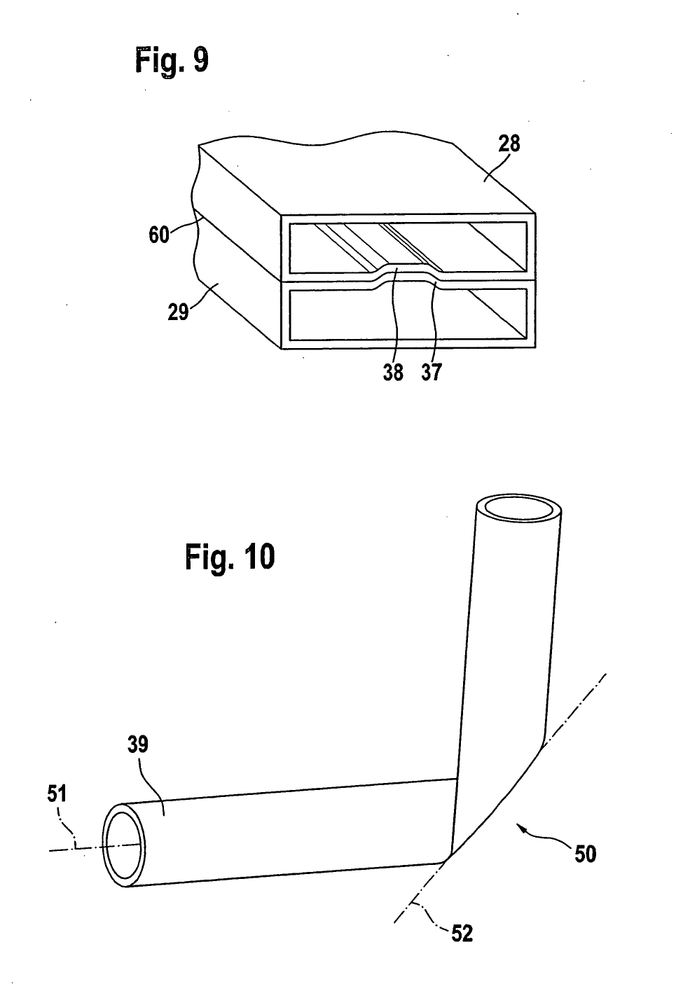

In order to ensure the stability of the longitudinal members with respect to forces which act transversely and shear the two hollow profile strands 28 and 29 apart from each other, the hollow profile strands 28 and 29 which lie on each other can have form-fitting and mating form-fitting elements in the form of correspondingly shaped depressions and elevations, for example in the form of ribs 37 and corresponding channels 38 according to FIG. 9 with an undercut-free cross section (here, for example, a trapezoidal cross section). The channels 38 can be produced before the bending of the longitudinal member hollow profile 2, 3 through 180° by an impressing operation or, in an economical manner in terms of method in the forming operation to produce the rectangular cross section of the longitudinal member hollow profiles 2, 3 by internal high pressure during the closure of the internal high pressure forming die or by one or more punches integrated in the forming die. The ribs 37 and the desired precise contour of the channels 38 can then be formed in the course of this internal high pressure forming. During the abovementioned bending operation, during the movement of the hollow profile strands 28, 29 toward each other, the rib 37 then engages in the shape-negative channel 38.

It is also conceivable, after the bending operation, when the two hollow profile strands 28, 29 bear against each other in the course of the production of the press fit by internal high pressure forming, for the rib 37 to be formed from the depression-free hollow profile strand 28 into the channel 38 formed in the lower hollow profile strand 29, which firstly has the advantage that a precise and therefore complicated bringing of the hollow profile strands 28, 29 toward each other is not required in order to achieve a form-fitting connection, and secondly that a method, which is required in any case, in order to secure the crossbar 5 and the cross member 4 can be used simultaneously in a manner economical for the method. The two hollow profile strands 28 and 29 are finally joined nonreleasably to each other, for example by welding in the parting line 60, in particular laser welding, gas tungsten pulsed-current arc welding or plasma pulsed-current welding. Adhesive bonding is likewise possible, with the lower side of the upper hollow profile strand 28 and/or the upper side of the lower hollow profile strand 29 being coated with an adhesive. The soldering of these surfaces is likewise conceivable, after which each part of the chassis frame 1 or the frame 1 as a whole has to be subjected to a heat treatment in a furnace.

FIG. 2 illustrates the front part of the chassis frame 1, which part contains two longitudinal member hollow profiles 39, 40, which run parallel and are spaced apart from each other in the horizontal plane, the crossbar 15 with the securing holes 8 for the securing of the transmission, a front cross member 41, body mountings 7 and 42, bearing mountings 43 for the longitudinal links and a spring strut mounting 44.

The front part is manufactured in a manner similar to that of the rear part of the chassis frame 1, but the crossbar 15 is arranged in the region of the open ends 45, 66 of the longitudinal members, which ends point toward the rear part. Following it toward the cross member 41, which, together with end-side body mountings 7 of the longitudinal members forms in the region of the bent edge 46 of the longitudinal member hollow profiles 39, 40, which are bent back on themselves through 180°, the front terminating component of the chassis frame 1, are the bearing mountings 43 for the longitudinal link, further body mountings 42 and then—in a section 47 bent in the vertical direction—the spring strut mounting 44. Although the section 47 does not absolutely have to be bent in some vehicles, such as in the case of trucks, this is indispensable for nonself-supporting bodywork structures (for example in the case of off-road vehicles). The bent portion can be formed in the first internal high pressure forming operation when profiling the longitudinal member hollow profiles 39, 40, which originally run rectilinearly, upon closure of the forming die which is designed corresponding to the shape. Furthermore, the crossbars 15 and 5 can be arranged in a manner such that they are displaced in the longitudinal position of the frame 1 in comparison to the exemplary embodiment shown such that an optimum protection with regard to a side impact is provided for the vehicle occupants.

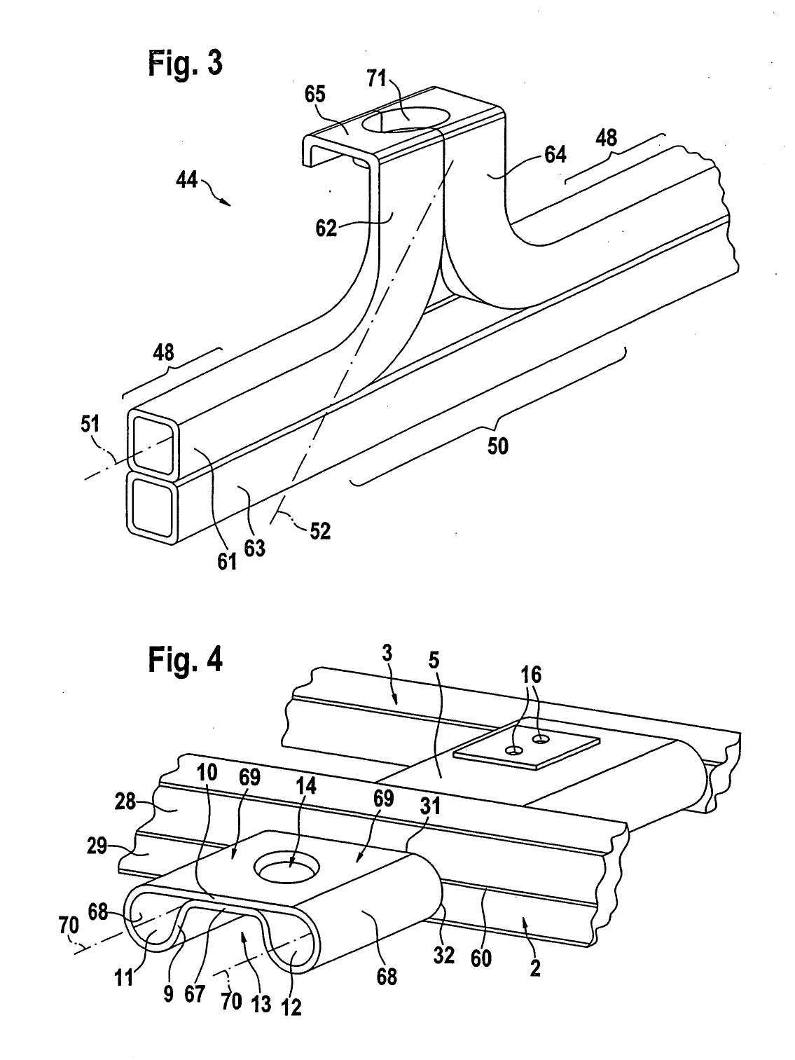

The production of each spring strut mounting 44 can take place before or after the first internal high pressure forming operation, with it being possible for them to be formed as a single piece from each longitudinal member hollow profile 39, 40 or to be manufactured as two pieces. In both cases, that section 50 of the respective hollow profile 39, 40 which is adjoined to the bent stage 49 toward the front cross member 41 is bent upward through an angle of at least 90° about a horizontal axis 52, which intersects the central longitudinal axis 51 of the hollow profile 39, 40 or—in this exemplary embodiment—of the upper hollow profile strand 61 at an angle of approximately 45° and can be seen from FIG. 3. Thus, the section 50 protrudes radially outward in a direction facing away from the other hollow profile 39, 40 and with respect to the directional profile of the rest of the hollow profile 39, 40. The hollow profile 39, 40 therefore protrudes laterally there, with regard to its essentially rectilinear directional profile, outside the spring strut mounting 44. After this bending operation, the lateral excess length is angled into a horizontal plane such that it points outward after a certain height offset with respect to the hollow profile 39, 40 running outside the spring strut mounting 44 and is flattened. After forming this half of the spring strut mounting 44 in this manner, in order to form the other half, the hollow profile 39, 40 itself (or in the case of a two-piece design of the hollow profile 39, 40, the second part of the hollow profile) is bent in a mirror-inverted manner with respect to this half, is angled in the same direction and flattened.

When a two-piece longitudinal member hollow profile 39, 40 according to FIGS. 2 and 3 is used, the interconnecting hollow profile strands 28, 29 of the rear part of the chassis frame 1 are independent components in themselves here. These are formed by an upper, shorter hollow profile strand 61, which has the body mounting 42 that is formed by internal high pressure and is in the vicinity of the crossbar, and the bearing mounting 43 for the longitudinal link and, with its end 62 in the vicinity of the cross member, forms one half of the spring strut mounting 44, and by a longer hollow profile strand 63 which runs essentially downward, is bent back on itself through 180° in the region of the cross member 41 and tapers to the end 62 of the upper hollow profile strand 61. The end 64 of the strand 63 forms the other half of the spring strut mounting 44, and the front body mounting 42 is formed by applying internal high pressure to the strand 63 in the region of the cross member 41. Those parallel ends 62 and 64 of the hollow profile strands 61 and 63, which i) point obliquely upward and outward in the transverse direction to the longitudinal axis 51 of the respective part 48 of the hollow profile strand 61 and 63 (which part does not belong to the spring strut mounting 44 and is situated next to it), and ii) protrude over this part 48 of the strand 61, 63 that part runs essentially rectilinearly and in the horizontal plane, are now bent over. In particular, they are folded over outward after a certain desired height offset with respect to said horizontal plane such that the ends 62 and 64 continue to run parallel to this plane.

Furthermore, the folded-over ends 62 and 64 are flattened and perforated in order to form the leadthrough 71 of the spring strut mounting 44. Before the perforation, the flattened portion 65 can be bent over at right angles downward on the end, so that the flattened portion 65 produces a flexurally stiff U profile. Finally (however, before the perforating operation, which can advantageously be brought about by punching), the flattened ends 62 and 64 are connected nonreleasably to each other (preferably welded) at their point of abutment. After the spring strut mounting 44 is formed in this manner, its ends 62 and 64 can be expanded by internal high pressure forming in the upwardly bent region to form struts with a roughly approximately circular cross section; this further increases the torsional and flexural rigidity of the spring strut mounting 44. In order to realize an end 64 of the hollow profile strand 63, which is expanded in such a manner a connecting opening must be provided on the latter, between the bent edge 46 of the longitudinal member hollow profile 39, 40 and the end 64 of the spring strut mounting 44, for the introduction of the hydraulic fluid, because the bent edge 46 of the longitudinal member hollow profile 39, 40 is relatively sharp and therefore a pressurization of the end 64 from that end 66 of the lower strand 63 which faces the rear part of the chassis frame 1 is not possible.

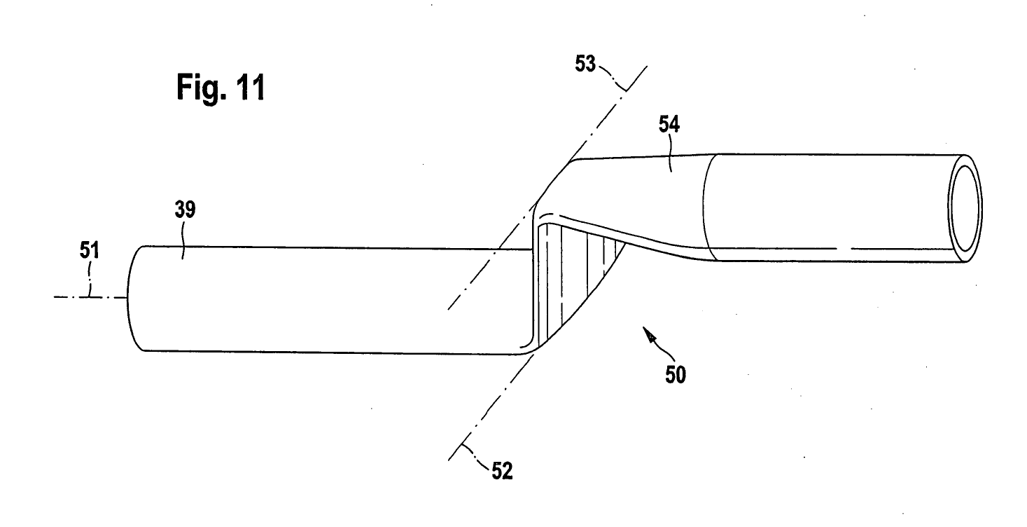

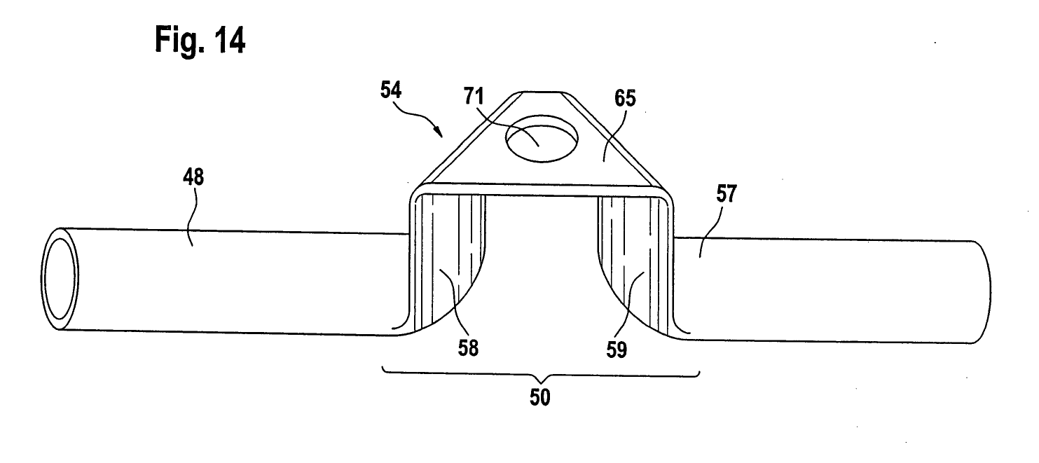

In a single-piece longitudinal member hollow profile 39, 40, the production of which (with regard to the spring strut mounting 44) is described below accompanied by FIGS. 10-14, the radially protruding section 50 is now bent forward through approximately 90°—parallel to the longitudinal direction of the longitudinal member hollow profile 39, 40—about a further parallel axis 53 spaced apart vertically from the horizontal axis 52, so that a subsection 54 of the section 50 lies approximately parallel to the longitudinal extent of the remaining hollow profile 39, 40 adjoining the spring strut mounting 44, but with a height and lateral offset thereto. In this case, one half of the spring strut mounting 44 extends from the rectilinear section 48, which is in the vicinity of the crossbar, at the foot of the bent-up region of the section 50 as far as the center of the subsection 54. The other half of the spring strut mounting 44 adjoins directly and extends from this center as far as the foot of the bent-down region of the rectilinear section 48 which is in the vicinity of the cross member.

Bending steps which are mirror-inverted with respect to these bending operations then take place. Following the subsection 54, the section 50 is namely bent downward and backward through approximately 90° about a likewise horizontal axis 55 which is situated at the same height as the parallel axis 53, but at an angle of approximately 90° with respect thereto, so that the end of the hollow profile 39, 40 is situated pointing radially inward with respect to the respective other hollow profile 39, 40. Finally, in the continuing sequence, the section 50 is bent forward through at least 90° about an axis 56 which is parallel to the horizontal axis 55 and is spaced apart in the vertical direction therefrom corresponding to the relative position of the horizontal axis 52 from the parallel axis 53, so that that end 57 of the section 50 which faces the front cross member 41 is approximately aligned with the part 48 of the hollow profile 39, 40 in front of the spring strut mounting 44. The subsection 54 protruding radially over the remaining longitudinal profile of the hollow profile 39, 40 is then flattened.

Subsequently, the longitudinal member hollow profile 39, 40 is placed into an internal high pressure forming die and, with the flattened portion 65 being retained, is expanded by application of an internal high pressure at both ends of the longitudinal member hollow profile 39, 40. In this connection, the previously mentioned shaping of the cross section of the longitudinal member, which originally has a circular cross section, and the formation of the body mountings 42 and of the bearing mountings 43 for the longitudinal links can take place at the same time. In a particularly advantageous manner, this internal high pressure forming operation, the cross sections of the two struts 58, 59 of the spring strut mountings 44 (which struts are formed by the bending operations, produce the height offset from the remaining longitudinal member hollow profile 39, 40 and are severely crushed during the bending), are formed circularly again in a rough approximation. As a result, a particularly high degree of flexural rigidity is conferred on the spring strut mounting 44.

Finally, the spring strut mountings 44 are perforated on their flattened portion 65, in an economical manner, in one working step, in the same manner as the bearing mountings 43 and the body mountings 42, by means of hole punches integrated in the internal high pressure forming die, in which the longitudinal member hollow profiles 39, 40 are formed by internal high pressure, with the leadthrough 71 of the spring strut mounting 44 being produced. Only then does the bending of the longitudinal member hollow profile 39, 40 through 180° take place with the bent edge 46 being produced.

With the bending technique described, it is possible even to integrate in the respective longitudinal member hollow profile 39, 40 as a single piece the spring strut mounting 44 which is offset severely in height and laterally from the actual profile of the longitudinal member hollow profiles 39, 40 and is of complex design, and, with as little outlay on material and joining as possible, to produce degrees of forming which cannot be realized solely by means of the internal high pressure forming technique. The double chamber profile of the longitudinal members compensates a possible weakening of the longitudinal member hollow profile 39, 40 in terms of flexural rigidity in the vertical direction at the location of the spring strut mounting 44, by the unweakened hollow profile strand 63 which runs downward and remains largely undeformed. In the case of the design of the spring strut mounting 44, the ductility of the hollow profile material (and therefore the flexibility or the deformability of the hollow profile 39, 40) can be improved, when steel is used, by intermediate annealing between the individual bending steps. When aluminum and other materials having a considerably lower melting point are used, this can take place by means of other types of heat treatment concentrated in particular locally on the to be bent.

It should be emphasized once more that one important integration step for reducing the diversity of components is the production of the spring strut mountings from the longitudinal member hollow profile by the special bending technique with which the longitudinal member hollow profile is formed. The single-piece design achieved therewith first of all makes it unnecessary to use complicated joining operations for joining a separate receiving console to the longitudinal member, which joining operations always constitute points of weakness in the stability of the frame construction (in particular in the event of high mechanical loads) and are exposed to function-reducing corrosion and joining deficiencies. At the same time, the single-piece design achieves an improvement in the torsional rigidity. Furthermore, an extremely high degree of clamping produced in the longitudinal member at the location of the spring strut mounting by the multiple bending operation particularly greatly increases the flexural and torsional rigidity of the spring strut mounting.

By the use of the internal high pressure forming technique, in which the longitudinal member is expanded, the region which is directly adjacent to the flattened region of the spring strut mounting and is provided with folds by the twisting and bending is expanded to form an approximately round, fold-free cross-sectional shape, and flexural rigidity is thus further increased. The expansion takes place in an economical manner in the course of the special and precise configuration of the cross-sectional shape and of the surface profile of the longitudinal member, which configuration is matched to the construction space, so that no further forming step is required during the production of the fold-free cross-sectional shape on the spring strut mounting. By means of the bending technique described, shapes can be produced on hollow profiles using high degrees of forming which, if they can be obtained at all, cannot be obtained, at least reliably, by internal high pressure forming with the corresponding expansion length. This applies in particular to the possible use in this case of lightweight construction materials of low ductility, such as, for example, most aluminum alloys, with which only low degrees of forming during expansion can be obtained by pure internal high pressure forming. As a result, even against this background, an even further saving on weight can be made during the production of the frame 1.

Both in the case of the single-piece design and in the case of the two-piece design of the longitudinal member hollow profiles 39, 40, the hollow profile strands 61 and 63, like the hollow profile strands 28 and 29 of the rear part of the chassis frame 1, are secured to each other.

After formation of the two parts of the chassis frame 1, the front part and the rear part are joined by plugging the ends 18 of the longitudinal member hollow profiles 2, 3 into the open ends 45, 66 of the longitudinal member hollow profiles 39, 40, which point toward the rear part. The ends 18 are finally welded or adhesively bonded to the ends 45, 46 in the plugged-in position with one another. The plug-in connection is very advantageous with regard to crash behavior in the case of a side crash because of the wall doubling obtained by the overlapping of the ends of the longitudinal member hollow profiles 2, 3 and 39, 40.

As an alternative for a nonreleasable securing of the two parts of the chassis frame 1 to each other even under a large application of force, it is also possible, in the plugged-in position, to press the ends of the longitudinal member hollow profiles onto one another in the overlapping region of the ends, by local internal high pressure forming and to expand them together in such a manner that a double-walled bulge is formed. This bulge is then composed of at least one inner form-fitting element, and preferably (for reasons of stability and durability of the mechanically highly loaded frame 1) from a plurality of inner form-fitting elements distributed over the circumference of the hollow profile end and formed at the end plugged in in each case, and from in each case one outer mating form-fitting element which is shape-negative with respect to said inner form-fitting element and is formed at the receiving end. In this case, the inner form-fitting element is fixed in an entirely form-fitting manner in the mating form-fitting element. For this internal high pressure forming operation, on that longitudinal member hollow profile which has the end to be plugged in, a connecting opening is provided in the region of the end, so that the hydraulic fluid can be introduced into the hollow profile and the pressurization can therefore take place.

Furthermore, it is also possible to form these form-fitting elements at the ends even before the ends are plugged together. In this case, any bulging or impressing technique or else the internal high pressure forming technique can be used. However, the form-fitting elements which correspond in shape to one another then have to be designed in such a manner that, within the scope of the elasticity of the hollow profile material of the end to be plugged in, the form-fitting elements can be briefly pressed back during plugging-in and can then snap into the mating form-fitting elements of the receiving end. As a result, the rear part of the chassis frame 1 is locked on the front part in a manner such that it is secure against displacement and rotation in the longitudinal direction and circumferential direction.

Finally, it is also possible for the mating form-fitting element to be formed in the receiving end by one of the abovementioned techniques, after which the other end is plugged in in an undeformed manner and only then, by means of internal high pressure forming, is the form-fitting element shaped into the existing mating form-fitting element. The form-fitting and mating form-fitting elements are to be designed such that they are undercut-free, so that, after the forming, the respective hollow profile can be removed again from the die in a manner free from becoming jammed.

The connection of the frame parts by means of form-fitting elements of this type enables the frame 1 to behave in a sufficiently rigid manner with respect to mechanical stresses as arise in the driving mode. In addition to its simple production, the connection described is advantageous in that, during repair situations, with an increased application of force the connection can be released in a relatively simple manner by detaching the form-fitting elements from the mating form-fitting elements, so that only the part in which damage has occurred has to be exchanged while the other part which is still usable can continue to be used.

As an alternative to the two-part frame 1 described, a single-part production of the frame 1 is also possible. In this case, a longitudinal member hollow profile is used which is approximately double the length of the longitudinal member in the finished frame 1, and the spring strut mounting 44 is formed by the bending technique described. Thereafter, the body mountings and the longitudinal link bearing mountings are formed by means of internal high pressure and the depressions for the subsequent mounting of the crossbars and the cross members are formed. In this case, the internal high pressure also has an effect on the formation of the struts of the spring strut mounting 44.

After the crossbars and the cross members are placed into the depressions, the longitudinal member hollow profile is then bent back on itself through 180° about a horizontal transverse axis at the locations of the ends of the future double chamber longitudinal member, so that the two hollow profile strands produced in this manner come to lie on each other and then extensively enclose the crossbars and cross members. The ends which, for example, run up to one another in the spring strut mounting and, correspondingly formed, form the two halves thereof or come to lie next to one another in the lower hollow profile strand and are plugged together, welded to one another or connected releasably to one another in another manner. Then, they are subsequently secured—as described in the case of the two-part frame—by actuation of the cavities of the crossbars and of the cross members by means of internal high pressure by the press fit produced during expansion and form-fitting connection in the depressions of the longitudinal member hollow profiles.

In the other variant, in which the respective longitudinal member hollow profile is expanded with the contour of the crossbars and of the cross members being retained, in order to secure them, at least one connection is to be provided for introducing the hydraulic fluid. Finally, due to tightness considerations, only then can the spring strut mounting and the perforations in the respective mountings be flattened. Because of the omission of the joining techniques when connecting two parts, the single-part version of the frame 1 requires less manufacturing outlay and produces a further reduction in components in the manufacturing of the frame 1. In addition, because of the virtually interruption-free, single-piece profile of the longitudinal members, which are stiffened in the manner of double chambers, it has a particularly rigid composition, which can be a positive feature for protection of individuals in the passenger cell during head-on and offset crashes.

It should be emphasized once more at this point that the spring strut mountings 44 can be designed according to the invention in a number of ways. Firstly, the longitudinal member hollow profile 39, 40 can be formed from two separate individual hollow profiles arranged in a row next to each other, irrespective of whether the hollow profile 39, 40 comprises one hollow profile strand or a plurality of strands lying one on another; only the uppermost strand has the spring strut mounting 44. The spring strut mounting 44 is divided here into two halves: one half is formed by bending and angling one end of the one individual hollow profile and the other half is formed by bending the facing end of the other individual hollow profile in a mirror-inverted manner with respect to the first half, and by angling the bent end of the other individual hollow profile in the same direction. The two halves are then connected fixedly to each other (preferably welded and/or adhesively bonded). Finally, the angled region is flattened and perforated, whereupon the spring strut mounting is finished.

Second, each of the longitudinal member hollow profile 39, 40 can be composed of two separate hollow profile strands 61 and 63 lying on each other and (as in the variant discussed above) the spring strut mounting 44 can be composed of two initially separate halves. One half of the spring strut mounting 44 is formed from that end 62 of the hollow profile strand 61 that is in the vicinity of the cross member, and the other half of the spring strut mounting 44 is formed from an end 64, which tapers to this end 62, of the longer hollow profile strand 63 which runs essentially downward and is bent back on itself through 180°. To a certain extent, by being bent back through 180°, the lower hollow profile strand 63 forms part of the upper strand 61. After the mirror-inverted bending with respect to each other according to the invention, the two ends 62 and 64 are thereafter angled in the same direction upward—as before—about an axis parallel to the longitudinal axis of that part of the longitudinal member hollow profile 39, 40 which does not belong to the spring strut mounting 44 and is situated next to it. The ends 62 and 64 which bear against each other are then connected nonreleasably, (preferably welded) at their point of abutment. The angled portion can then be flattened and perforated before or after the joining operation.

Furthermore, the spring strut mounting 44 of the frame 1 can be formed as a single piece from the longitudinal member hollow profile 39, 40, with the hollow profile 39, 40 comprising a single hollow profile strand. In this case, longitudinal member hollow profile 39, 40 is bent back at both ends through 180°, with its ends subsequently being bent in a mirror-inverted manner with respect to each other about the horizontal axis 52. One half of each spring strut mounting 44 is formed, and is angled in the same direction; and subsequently the halves that bear laterally against each other are connected fixedly to each other. The flattening and perforating of the angled portion can likewise take place before or after the joining operation.

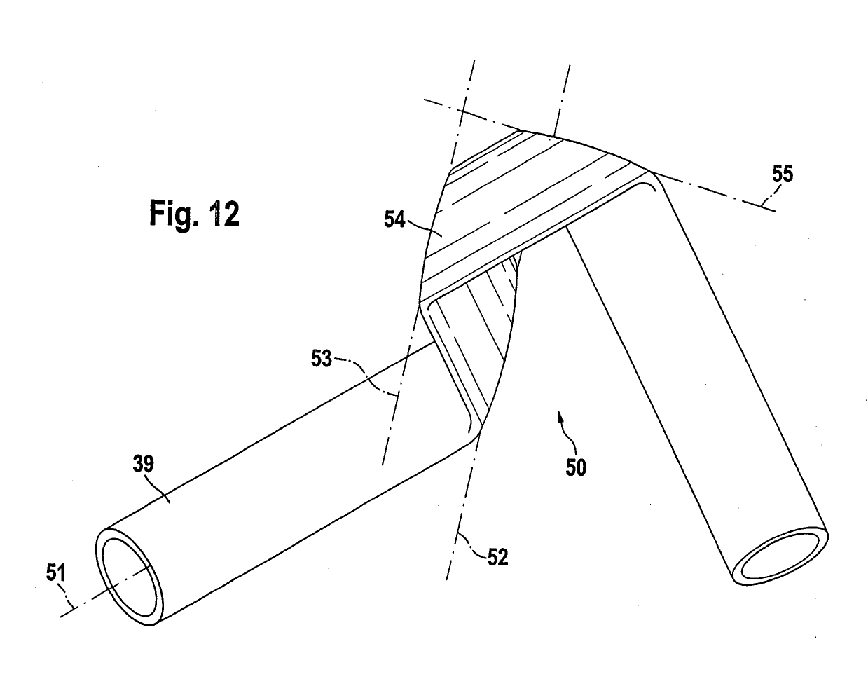

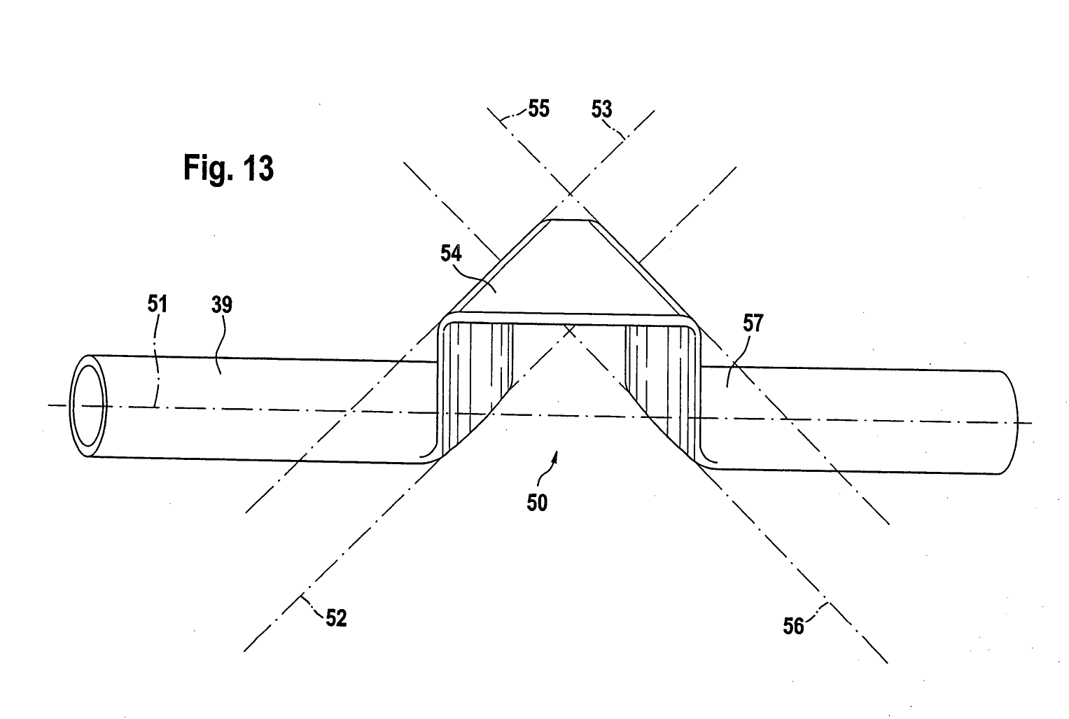

Furthermore, the spring strut mounting 44 can be formed without a separating joint of the halves. For this purpose, the radially protruding section 50 is bent forward through approximately 90° about a further parallel axis 53 spaced apart vertically from the horizontal axis 52, after which it runs parallel to the longitudinal direction of the longitudinal member hollow profile 39, 40, so that a subsection 54 of the section 50 lies approximately parallel to the longitudinal extent of the remaining longitudinal member hollow profile 39, 40 adjoining the spring strut mounting 44, but with a height and lateral offset thereto. The one half of the spring strut mounting 44 extends as far as the center of the subsection 54. The other half of the spring strut mounting 44, which runs from the center of the subsection 54 in the direction of the front cross member 41, is produced in a simple manner by mirror-inverted further bending of the section 50 following the subsection 54 according to FIGS. 12 and 13. Thereafter, the angled region resulting from the special bending operation is flattened and perforated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for producing a vehicle component, which includes spring strut mountings, elongate; wherein:
horizontally disposed spaced apart parallel elongate tubular longitudinal member hollow profiles are connected nonreleasably to one another at respective longitudinal ends thereof, by tubular cross member hollow profiles;
a hollow-profile-like crossbar for receiving a rear axle, a differential and a transverse link, and a hollow-profile-like crossbar, which is spaced apart in the longitudinal direction and is adapted to secure a vehicle transmission between the two end-side cross member hollow profiles, are secured on the longitudinal member hollow profiles;
size and shape of the cross section of the longitudinal member hollow profiles are formed in an expanding manner by means of internal high pressure forming;
body mountings of the frame are formed by forming secondary shaped elements laterally from the longitudinal member hollow profile by application a fluidic internal high pressure and subsequent vertical perforation of the secondary shaped elements;
unperforated secondary shaped elements, which contain an edge of the upper side of the respective longitudinal member hollow profile are formed, and are thereafter pinched flat such that a radially protruding sheet-metal fold is formed; and
bearing mountings of longitudinal links are likewise formed, as secondary shaped elements, laterally outward from the longitudinal member hollow profile by fluidic internal high pressure, and are subsequently perforated.

2. The method as claimed in claim 1, wherein the body mounting is pinched flat in an internal high pressure forming die by closing the die with the radially protruding sheet-metal fold being formed.

3. The method as claimed in claim 1, wherein the body mountings, the bearing mountings, the longitudinal links, and the spring strut mountings are perforated by hole punches which are integrated into an internal high pressure forming die, in which the longitudinal member hollow profiles are formed by internal high pressure.

4. The method as claimed in claim 1, wherein:
the longitudinal member hollow profiles are doubled by being bent through 180° about a horizontal axis running transversely, so that two resultant hollow profile strands come to lie on each other;
body mountings and bearing mountings of the longitudinal links are formed on the hollow profile strand situated on top; and
bent edges form the ends of the longitudinal members of the frame.

5. The method as claimed in claim 4, wherein:
before bending of the longitudinal member hollow profile, depressions are introduced into the longitudinal member hollow profile mechanically by one of a punch and internal high pressure forming thereof, and the respective cross member hollow profile is placed into said depressions; and
after the bending operation, the respective cross member hollow profile is extensively enclosed.

6. The method as claimed in claim 4, wherein:
before bending of the longitudinal member, in which the crossbars are arranged, depressions are introduced into the longitudinal member hollow profile, and the respective crossbar is placed into said depressions; and
after the bending, the cross bar is extensively enclosed.

7. The method as claimed in claim 1, wherein:
the crossbar is formed from an oval tube;
a central region of at least one longitudinal side of the oval tube is pressed in by means of a punch until its longitudinal sides come to bear against each other;
thereafter, side cavities which arise are expanded by applying internal high pressure, with the longitudinal sides continuing to bear against each other, to form tubes which run parallel and have an approximately circular cross section; and in a central region of the longitudinal sides, the rear axle mountings, the holes of the securing mountings for the differential and the securing holes for securing the transmission are punched out or produced by metal-cutting.

8. The method as claimed in claim 5, wherein:
the cross member hollow profiles and the crossbars are encircled by bending the longitudinal member hollow profiles through 180°;
resultantly formed longitudinal member hollow profile strands are secured on one another; and
thereafter, at least one of the latter is expanded by applying internal high pressure until the cross member hollow profiles and the crossbars in leadthroughs formed by the depressions of the longitudinal member hollow profiles are nonreleasably press fitted together.

9. The method as claimed in claim 8, wherein, during expansion of the longitudinal member hollow profile strands, one of the cross members and the crossbars of hollow design are acted upon from inside with a deformation-preventing, fluidic counterpressure.

10. The method as claimed in claim 5, wherein one of the cross members and the crossbars of hollow design are expanded by a fluidic high pressure at a location of leadthroughs formed by the depressions of the longitudinal member hollow profiles.

11. The method as claimed in claim 10, wherein, during expansion of one of the cross members and/or and of the crossbars, the two hollow profile strands of the longitudinal member hollow profiles are acted upon with a deformation-preventing, fluidic counterpressure.

12. The method as claimed in claim 1, wherein, in the case of a two-part design of the frame with a division between the crossbars, the mutually facing ends of the longitudinal member hollow profiles are inserted one inside another and are subsequently connected nonreleasably to one another.

13. The method as claimed in claim 12, wherein one of the following is true:
ends which are inserted one inside another are welded to one another; and
after forming at least one form-fitting element at an end receiving the end to be inserted by means of internal high pressure with a shape-negative mating form-fitting element being formed, are fixed in a form-fitting manner at the location of the form-fitting element.

14. The method as claimed in claim 1, wherein:
a spring strut mounting of the frame is formed from the longitudinal member hollow profile;
the longitudinal member hollow profile is bent upward by an angle of at least 90° on a section at a location about a horizontal axis, which intersects the central longitudinal axis of the hollow profile at an angle of approximately 45°, such that the hollow profile protrudes laterally, with regard to its essentially rectilinear directional profile, outside the spring strut mounting; and
thereafter, lateral excess length is angled in order to form the spring strut mounting with a preset height offset relative to the hollow profile running outside the spring strut mounting.

15. The method as claimed in claim 14, wherein:
the longitudinal member hollow profile is formed from two separate contiguous individual hollow profiles;
a first half of the spring strut mounting is formed by bending and angling one end of the one individual hollow profile;
the other half of the spring strut mounting is formed by bending a facing end of the other individual hollow profile is bent us in a mirror-inverted manner with respect to the first half, and is angled in the same direction; and
thereafter the two halves are connected fixedly to each other.

16. The method as claimed in claim 14, wherein:
each longitudinal member hollow profile is composed of two contiguous separate hollow profile strands;
a first half of the spring strut mounting is formed from a first end of the hollow profile strand that is in the vicinity of the cross member;
the other half of the spring strut mounting is formed from a second end, which tapers to the first end, of the longer hollow profile strand, runs essentially downward and is bent back on itself through 180°;
the first and second ends are angled about an axis parallel to the longitudinal axis of a part of the longitudinal member hollow profile which does not belong to the spring strut mounting and is situated next to it; and,
after they are flattened at their point of abutment, the first and second ends bearing against each other are connected nonreleasably.

17. The method as claimed in claim 14,
the spring strut mounting of the frame is formed as a single piece from the longitudinal member hollow profile, which is bent back at both ends through 180°;
extremities of the longitudinal member hollow profile subsequently are bent in a mirror-inverted manner with respect to one another about the horizontal axis;
one half of each spring strut mounting is formed, and angled in the same direction; and
thereafter, the halves bearing laterally against each other are connected fixedly to each other.

18. The method as claimed in claim 14, wherein:
a radially protruding section is bent forward through approximately 90°; parallel to a longitudinal direction of the longitudinal member hollow profile, about a further parallel axis spaced apart vertically from the horizontal axis, so that a subsection of the radially protruding section lies approximately parallel to a longitudinal extent of the remaining longitudinal member hollow profile adjoining the spring strut mounting, but with a height and lateral offset thereto, with the one half of the spring strut mounting extending as far as the center of the subsection; and
production of the other half of the spring strut mounting, which half runs from the center of the subsection in the direction of a front cross member, takes place by mirror-inverted further bending of the section following the subsection.

19. The method as claimed in claim 18, wherein the lateral excess length is angled into a horizontal plane.

20. The method as claimed in claim 19, wherein the angled portion is flattened.

21. The method as claimed in claim 20, wherein the flattened portion is perforated.

22. The method as claimed in claim 21, wherein the flattened portion of the ends is bent downward at a right angle on the end side.

23. The method as claimed in claim 22, wherein:
after bending of the longitudinal member hollow profile to form the spring strut mounting, the spring strut mounting is acted upon at both ends by internal high pressure; the cross section of the longitudinal member hollow profile, which is severely crushed during the bending of its two struts, producing the height offset with respect to the remaining longitudinal member hollow profile, is expanded to form a circular cross section in rough approximation.

24. The method as claimed in claim 23, wherein form-fitting elements in the form of depressions, are formed on upper sides of the longitudinal member hollow profiles by means of a punch.

25. The method as claimed in claim 24, wherein mating form-fitting elements from the depression-free hollow profile strand, are formed in the form-fitting elements by internal high pressure forming, after bending to double the respective longitudinal member hollow profile.
